(19) United States
(12) Patent Application Publication
(10) Pub. No.: US 2004/0100443 A1
(43) Pub. Date: May 27, 2004

(54) Method and system to allow panoramic visualization using multiple cameras

(75) Inventors: Robert Mandelbaum, Bala Cynwyd, PA (US); George Herbert Needham Riddle, Princeton, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 10/688,435

(22) Filed: Oct. 17, 2003

Related U.S. Application Data
(60) Provisional application No. 60/419,462, filed on Oct. 18, 2002.

(51) Int. Cl. G09G 5/08

(52) U.S. Cl. 345/158

(57) ABSTRACT

A panoramic visualization system has multiple cameras with overlapping fields of view. A pointing device supplies view port direction information to a processing system, which blends the fields of view to produce panoramic view data that represents the panoramic view imaged by the cameras. The processing system also produces view port data along the view port direction. The processing system uses a vision processing board. A display device images the view port data to show an image area. The processing system beneficially corrects for the relative positions of the cameras, for the lens distortions of the individual cameras, and for roll, pitch, and yaw. The system may include an auto-track assembly that automatically moves the view port to track a moving object, while the processing system may enable multiple users to view multiple view ports. The cameras are beneficially mounted on a vehicle.

### CROSS-REFERENCE TO RELATED APPLICATIONS

This application claims the benefit of U.S. provisional patent application serial No. 60/419,462, filed Oct. 18, 2002, which is herein incorporated by reference.

### BACKGROUND OF THE INVENTION

1. Field of the Invention

The present invention relates to using multiple cameras to obtain a panoramic visualization of an area.

2. Description of the Related Art

The occupants of armored vehicles, e.g., military or security vehicles, often need to observe what is happening around their vehicle without exposing themselves to an enemy. In the past, bulletproof glass prism blocks have been used for this purpose.

More recently, gimbaled-mounted cameras have been used to provide panoramic views that are shown on flat panel displays (FPDs) or on helmet-mounted displays (HMDs). In such systems the viewing direction is usually adjustable by changing the viewing direction of the gimbaled-mounted camera. Often, a pointing device, such as a joystick or a head tracker, controls the viewing direction. If a head tracker is used, the viewing direction can be configured to correspond to what would be seen by the viewer, thereby providing a highly intuitive method of viewing an area.

Another approach to observing what is happening around armored military vehicles is to position a set of cameras external to the vehicle so as to acquire images from all directions. Those images can be collected and electronically processed to provide images along a desired viewing direction. Such provided images are referred to herein as a view port. An example of such an approach can be found in Belt et al, “Combat Vehicle Visualization System,” Proceedings of SPIE, v. 4021, p. 252 (2000).

While the foregoing approaches are beneficial in that they enable panoramic visualizations without exposing the occupants of armored military vehicles to danger, and are thus highly advantageous in hostile environments, they are not optimal. While prism blocks are beneficial, such blocks provide views that are limited both horizontally and vertically. Gimbaled-mounted cameras have the drawback in that inherent mechanical motion delays limit the speed with which the desired view port can be changed. Furthermore, multiple camera systems have suffered from the serious drawback that they have required large, bulky, highly sophisticated, and expensive special purpose computers for image capture and processing.

Therefore, a multiple camera panoramic visualization system that does not require a special purpose computer would be beneficial. Such a multiple camera panoramic visualization system that smoothly blends neighboring fields of view together would be particularly useful. Also beneficial would be a multiple camera panoramic visualization system that enables multiple users to select their own viewing directions. A multiple camera panoramic visualization system that corrects for various imaging problems, such as lens distortion, and roll, pitch, and yaw would also be useful. In some applications, a multiple camera panoramic visualization system capable of manually and/or automatic tracking of moving objects within the panoramic viewing area would be very useful.

### SUMMARY OF THE INVENTION

The principles of the present invention provide for a new, multiple camera panoramic visualization system that does not require a special purpose computer, but which can smoothly blend neighboring fields of view together. Such a multiple camera panoramic visualization system can be implemented so as to enable multiple users to select their own viewing directions, so as to enable manual and/or automatic tracking of moving objects, and so as to correct for various imaging problems, such as lens distortion, and roll, pitch, and yaw correction.

A panoramic visualization system that is in accord with the present invention includes a plurality of cameras, each of which produces image data from that camera's field of view. Furthermore, each camera's field of view overlaps with a neighboring field of view. A pointing device supplies view port direction information to a processing system, which also receives the image data from the cameras. The processing system beneficially blends the image data from the overlapping fields of view to produce panoramic view data that represents the panoramic view imaged by the cameras. The processing system then produces view port data along the view port direction, based on the panoramic view data. The processing system itself includes a vision processing board.

A display device, such as a helmet mounted display, a CRT, or a flat panel display can be used to image the view port data. In practice, a suitable pointing device may be a mouse, a head tracker, a touch screen, or a joystick.

Furthermore, the processing system beneficially corrects for the relative positions of the individual cameras, for the lens distortions of the individual cameras, and for roll, pitch, and yaw. However, corrective methods to address lens distortions can be omitted if such lens distortions are addressed by the cameras or are within acceptable limits.

The panoramic visualization system may include a control assembly that produces control information that controls the view port data. Additionally, the panoramic visualization system may include an auto-track assembly that automatically moves the view port to track a moving object. Furthermore, the panoramic visualization system may include multiple pointing devices, and the processing system may produce multiple view ports to enable multiple users to visualize areas selected by the individual users. In such systems, multiple display devices may be used. Beneficially, the panoramic visualization system may be implemented with the cameras mounted on a moving vehicle (such as a tank).

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a top-down view of a plurality of imaging cameras that are configured to provide a panoramic view of an area;

FIG. 2 illustrates overlapping fields of view of the plurality of imaging cameras shown in FIG. 1;

FIG. 3 is a block diagram of a panoramic viewing system that is in accord with the principles of the present invention;

FIG. 4 illustrates an embodiment of an image processing system used in the panoramic viewing system of FIG. 3;

FIG. 5 illustrates the use of multiple video cards in the panoramic viewing system of FIG. 3;

FIG. 6 illustrates a panoramic viewing system that includes an auto-track module; and

FIG. 7 illustrates a panoramic viewing system mounted on an armored military vehicle.

### DETAILED DESCRIPTION OF THE PREFERRED EMBODIMENT

The principles of the present invention provide for a multiple camera panoramic visualization system that does not require a special purpose computer. A panoramic visualization system that is in accord with the principles of the present invention is capable of smoothly blending neighboring fields of view together. Furthermore, some embodiments can enable multiple users to select their own viewing directions. Furthermore, other embodiments can be configured to manually and/or automatically track moving objects within the panoramic viewing area.

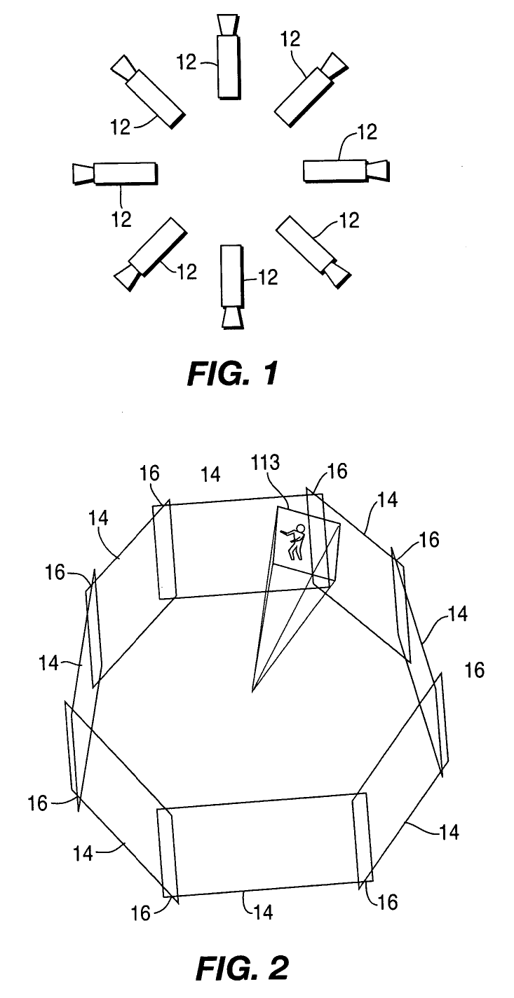

Referring now to FIG. 1, the panoramic visualization system includes a plurality of imaging cameras 12. The imaging cameras are preferably located at fixed relative positions such that transformation parameters relating to the camera positions can be determined during a calibration procedure. Those transformation parameters are subsequently used to provide a common coordinate frame for all of the cameras and all of the views. While FIG. 1 is a top-down view of a plurality of cameras, other orientations, such as vertically orientated cameras that face outward-imaging mirrors, are also possible. Additionally, lens distortion correction parameters, which relate to various lens properties, can also be determined during the calibration procedure. The lens distortion correction parameters enable improved optical performance, particularly when blending neighboring fields of view.

FIG. 2 illustrates the fields of view 14 of the imaging cameras 12. Those fields of view define the overall panoramic view of the system. Beneficially, the fields of view 14 overlap 16 so as to enable smooth blending of neighboring fields of view 14. While FIGS. 1 and 2 show circularly configured imaging cameras 12 and fields of view 14, this is not a requirement. The principles of the present invention are applicable to multiple cameras that have other scopes of coverage (such as 45 degrees) and that have different camera location configurations. Thus, it is possible to deploy the cameras in a configuration where more than two fields of view 14 may overlap.

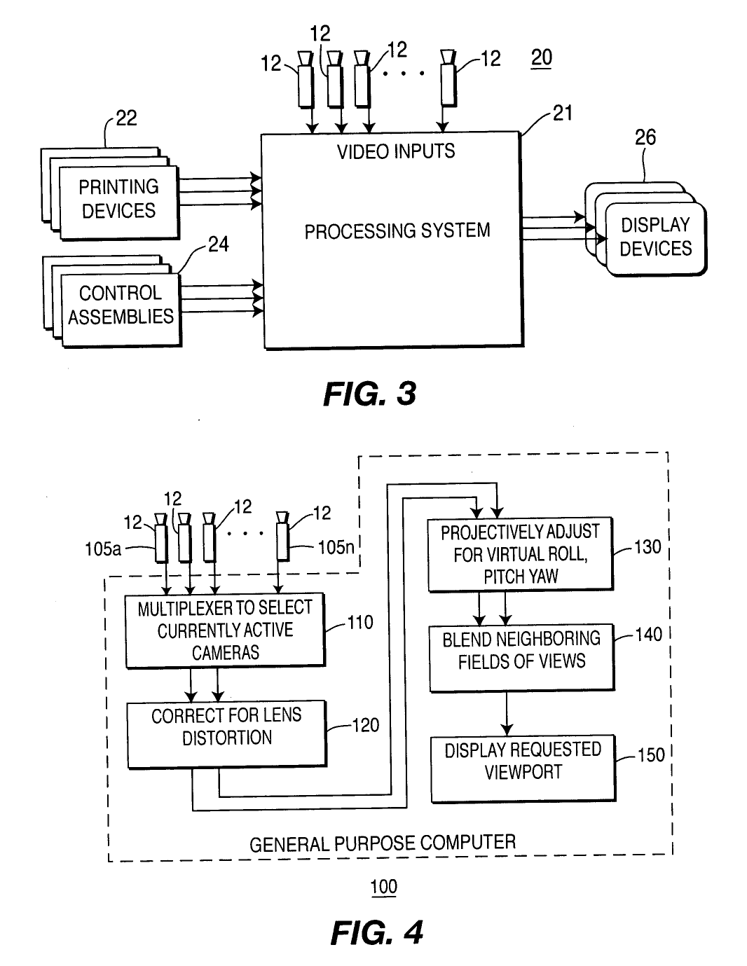

FIG. 3 illustrates a panoramic viewing system 20 that includes a processing system 21 that electronically processes the image data from the imaging cameras 12. The panoramic viewing system 20 also includes one or more pointing devices 22, one or more control assemblies 24, and one or more display devices 26. The pointing devices and control assemblies provide information related to the desired view port (see below) and field of view information, as well as operator control information, to the processing system 21. The display devices provide a user or users with an image of the view port.

The processing system 21 includes a personal computer (pc), such as a pc using a Windows operating system, and having a PCI bus that accepts specialized processing boards. Such specialized processing boards include vision processing boards such as the Acadia vision accelerator manufactured by Pyramid Vision Technologies, Inc. A typical pointing device 22 might be a keyboard, a mouse, a joystick, a trackball, a touch screen, or a head tracker. A typical control assembly 24 might include electrical switches to switch between forward and rearward viewing, and a zoom control. A typical display device might be a flat panel display, a CRT, or a helmet mounted display. It should also be noted that the display device might be a recorder, such as a camera or memory.

The panoramic viewing system 20 requires a significant amount of image processing. FIG. 4 illustrates one embodiment of a suitable image processing system 100. It should be noted that FIG. 4 illustrates both a flowchart that shows processing steps and a block diagram of a processing system having a plurality of modules.

The image processing system 100 receives overlapping field of view 16 image information from the imaging cameras 12. The received image information is applied to a multiplexer 110, which selects from among the various streams from the imaging cameras. The selected video streams are based on information from the pointing devices 22 and from the control assemblies 24 (see FIG. 3). For example, referring now to FIG. 2, the image processing system 100 might be tracking an object, say a hostile in an image area 113, based on a gunner's head tracker.

Referring again to FIG. 4, based on the lens distortion correction parameters determined during calibration, the warped camera images are corrected for lens distortion by a module 120 using a projective flowfield, or a non-projective flowfield that is approximates a projective flowfield by a piecewise (tiled) quadratic transformation. The lens distortion corrected video streams are then projectively corrected for virtual roll, pitch and/or yaw via a module 130. The adjusted video streams are then blended together to provide a seamless panorama by module 140. The seamless panorama is then provided to a display as a view port via module 150. That view port, which displays the desired image area 113, has been electronically adjusted to account for virtual camera rotations, lens distortions and other artifacts. The view port is identical to or closely approximates the view that would be obtained from a camera that is actually pointed in the direction of the image area 113. It should be noted that most of the image processing system 100 is implemented using a single video processing board, such as an Acadia vision accelerator board. Thus, the vision accelerator reduces the computational requirements of the main computer.

The panoramic viewing system 20 has advantages over gimbaled systems in that the same set of cameras can simultaneously provide views in different directions to different viewers. Moreover, the panoramic viewing system 20 is faster and accounts for virtual camera pan, tilt, and roll. Traditional gimbaled systems typically cannot account for roll. Furthermore, the panoramic viewing system 20 has no moving parts, and has the ability to “jump” from view port to view port without having to pan through intervening points.

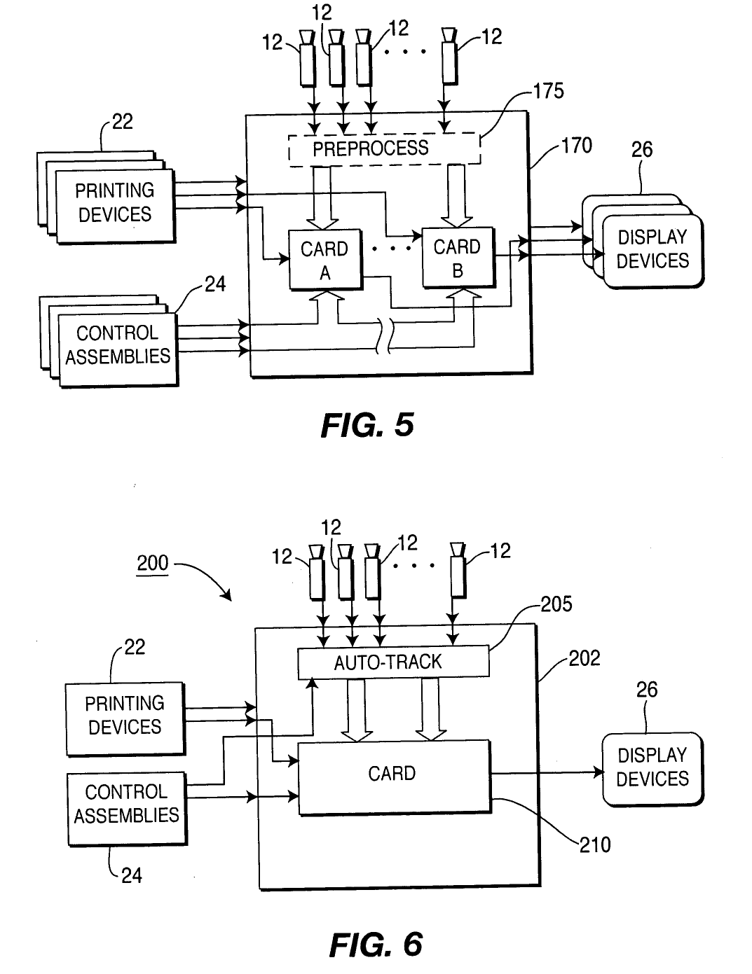

While the panoramic viewing system 20 shown in FIG. 3 is useful, in some applications it may not be optimal. For example, FIG. 5 illustrates an embodiment of the present invention in which a processing system 170 includes multiple video processing cards, only two of which, card A and card B, are shown. FIG. 5 further illustrates an optional preprocessor 175. In operation, imaging data from the imaging cameras 12 are applied in parallel to both card A and card B. If used, the preprocessor 175 digitally processes the incoming imaging data to accomplish a common task, say lens distortion correction. Cards A and B further receive parallel information from control assemblies 24. However, each card receives pointing information from a different pointing device 22. This enables two users to view different view ports. Furthermore, the optional preprocessor 175 enables one preprocessor to handle tasks that are common to all cards.

Another embodiment of the present invention is shown in FIG. 6. FIG. 6 illustrates a panoramic visualization system 200 that includes a processing system 202 having an auto-track module 205. The auto-track module 205 receives image data from the imaging cameras 12. The auto-track module also receives information from a pointing device 22 that identifies an image area 113 (see FIG. 2) that may have a moving object. Based on variations in the image data from the imaging cameras, and on control information from the control assembly 24, the auto-track module will automatically move its view port to track a moving object. Moving object detection is well known to those skilled in the applicable arts. Reference, for example, U.S. Pat. No. 6,081,606, issued on Jun. 27, 2000 to Hansen et al., and U.S. Pat. No. 6,434,254, issued on Aug. 13, 2002 to Wixson.

Still referring to FIG. 6, alternatively the control information from the control assembly 24 and information from the pointing device 22 can be such that the view port is manually adjusted to find a moving target. Then, auto-tracking of the moving target can be initiated by an operator or by a software routine.

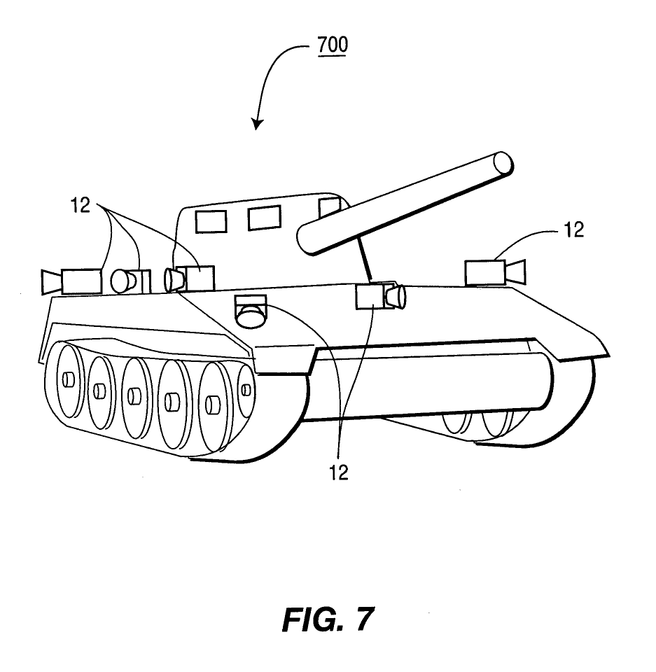

The principles of the present invention can be used to protect occupants of moving vehicles such as armored military or security vehicles. Such occupants can then observe what is happening around their vehicle without exposing themselves to an enemy. For example, FIG. 7 illustrates a panoramic viewing system attached to a tank 700 wherein the cameras 12 are externally mounted to the tank body. An operator or operators inside the tank 700 can use pointing devices to supplying view port direction information to the processing system.

While foregoing is directed to the preferred embodiment of the present invention, other and further embodiments of the invention may be devised without departing from the basic scope thereof, and the scope thereof is determined by the claims that follow.

1. A panoramic visualization system, comprising:
a plurality of cameras, each of which produces image data from its field of view, wherein each camera's field of view overlaps with a neighboring field of view;
a pointing device for supplying view port direction information; and
a processing system for receiving said view port direction information and said image data from said plurality of cameras, said processing system for producing view port data from said received image data in response to said received view port direction information, wherein said processing system blends said image data from overlapping fields of view to produce panoramic view data that represents a panoramic view, wherein said view port data represents a portion of said panoramic view that is selected by said view port direction information; and wherein said processing system corrects the view port data for relative positions of said plurality of cameras.

2. The panoramic visualization system according to claim 1, wherein each camera of said plurality of cameras includes a lens, and wherein said processing system corrects said view port data for lens distortion of said plurality of cameras.

3. The panoramic visualization system according to claim 1, further including a display device for displaying said view port data.

4. The panoramic visualization system according to claim 3, wherein said display device is selected from a group comprising of a helmet mounted display, a CRT, and a flat panel display.

5. The panoramic visualization system according to claim 1, further including a control assembly that produces control information, wherein said processing system produces said view port data based on said control information.

6. The panoramic visualization system according to claim 5, wherein said pointing device is selected from a group comprising of a mouse, a head tracker, a touch screen, and a joystick.

7. The panoramic visualization system according to claim 1, wherein said processing system automatically tracks a moving object.

8. The panoramic visualization system according to claim 1, wherein said processing system corrects said view port data for roll, pitch, or yaw.

9. The panoramic visualization system according to claim 1, wherein said plurality of cameras are mounted on a moving vehicle.

10. The panoramic visualization system according to claim 1, wherein said processing system employs a vision processing board.

11. A panoramic visualization system, comprising:
a plurality of cameras, each of which produces image data from its field of view, wherein each field of view overlaps with a neighboring field of view;
a first pointing device for supplying first view port direction information;
a second pointing device for supplying second view port direction information; and
a processing system for receiving said first view port direction information, said second view port direction information, and said image data from said plurality of cameras, said processing system for producing first view port data from said received image data in response to said received first view port direction information, said processing system further for producing second view port data from said received image data in response to said received second view port direction information, wherein said processing system blends image data from overlapping fields of view to produce panoramic view data that represents a panoramic view, wherein said first view port data represents a portion of said panoramic view that is selected by said first view port direction information, wherein said second view port data represents a portion of said panoramic view that is selected by said second view port direction information, and wherein at least one of the view ports automatically tracks a moving object.

12. The panoramic visualization system according to claim 11, further including a first display device for displaying said first view port data and a second display device for displaying said second view port data.

13. The panoramic visualization system according to claim 12, wherein said first display device is selected from a group comprising of a helmet mounted display, a CRT, and a flat panel display.

14. The panoramic visualization system according to claim 11, further including a control assembly that produces control information, wherein said processing system produces said first view port data based on said control information.

15. A method of visualizing a panoramic view, comprising:
locating a plurality of cameras having lenses such that the cameras produce images having overlapping fields of view;
obtaining view port direction information; and
processing the images to produce panoramic view data that represents a portion of the panoramic view selected by the view port direction information and such that distortion produced by the camera lenses is corrected.

16. The method of claim 15, further including displaying the view port data.

17. The method of claim 15, wherein multiple view port direction information is obtained, and wherein multiple panoramic views, each selected by associated view port direction information, are produced.

18. The method of claim 17, further including displaying multiple panoramic views.

19. The panoramic visualization system according to claim 15, wherein the processing automatically tracks a moving object.

20. A vehicle vision system comprising:
a vehicle body;
a plurality of cameras mounted to said body, wherein each camera produces image data from its field of view, and wherein each camera's field of view overlaps with a neighboring field of view;
a pointing device for supplying view port direction information; and
a processing system for receiving said view port direction information and said image data from said plurality of cameras, said processing system for producing view port data from said received image data in response to said received view port direction information, wherein said processing system blends said image data from overlapping fields of view to produce panoramic view data that represents a panoramic view, wherein said view port data represents a portion of said panoramic view that is selected by said view port direction information, and wherein the processing system automatically tracks a moving object.
